(19) United States
(12) Patent Application Publication
(10) Pub. No.: US 2003/0178323 A1
(43) Pub. Date: Sep. 25, 2003

(54) Method and apparatus for anlyzing a component in a liquid sample

(76) Inventors: Andreas Fiedler, Tubingen (DE); Christoph Pfefferle, Dettingen an der Erms (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/303,584

(22) Filed: Nov. 22, 2002

Related U.S. Application Data
(63) Continuation of application No. PCT/EP01/05715, filed on May 18, 2001.

(30) Foreign Application Priority Data
May 22, 2000 (DE) 10024947.7

(51) Int. Cl. G01N 27/26

(52) U.S. Cl. 205/782; 205/786.5; 204/409

(57) ABSTRACT

An apparatus for determining a component present in a liquid sample in free state or bound to constituents, preferably for measuring the SO₂ content in the sample, has a locating space for the liquid sample, a sensor preferably responding selectively to the component, preferably based on an electrochemical cell, and a gas piping system via which a carrier gas can be passed from the locating space through the sensor (FIG. 1).

### RELATED APPLICATION

This is a continuation application of International Patent Application PCT/EP01/05715 published as WO 01/90742 A1.

### BACKGROUND OF THE INVENTION

1. Field of the Invention

The present invention relates to an apparatus for determining a component present in a liquid sample in free state and/or bound to constituents, preferably for measuring the SO₂ content in the sample, further preferably for measuring the SO₂ content in wine or a wine-containing sample. The invention further relates to a method for determining a component present in a liquid sample in free state and/or bound to constituents, preferably SO₂, further preferably in wine, in which the component is analyzed in the gas phase from a gas space over the sample.

2. Description of the Related Art

A method of the type mentioned at the outset which serves for measuring the SO₂ content in wine or fruit juices is described in C. S. Ough: “Determination of Sulfur Dioxide in Grapes and Wines”, published in Linskens & Jackson: Modern Methods of Plant analysis, Volume 6: Wine analysis, Springer Verlag 1988.

Sulfur dioxide (SO₂) is certainly the component most frequently analyzed and measured in wine. However, in fruit juices or in other foods even of a solid consistency, SO₂ is also, for health reasons, a component not to be neglected.

Furthermore, SO₂ is of importance in environmental analysis, for example in monitoring systems for exhaust air, flue gas desulfurization, lower toxic limit determination etc.

For many fields of use of SO₂, legislators have in the meantime established limiting values which must be complied with by the industry, the producer and filling enterprises, and therefore must be regularly monitored.

Avoidance of SO₂ for example in wine making, is frequently only possible up to a certain extent, since SO₂ is used, for example, during sulfur treatment of the wine barrels, but also serves as preservative and is generally considered an indispensable component for high quality wine producing. Nevertheless, SO₂ has disadvantageous side effects for health which manifest themselves, for example, in severe headaches after the consumption with wines with a high SO₂ content.

Furthermore, there are, in particular in the case of wine, a great number of wine faults and wine disorders which are caused by unwanted components or excessive concentrations of components. These include, for example, the acetic spoilage caused by acetic acid, the lactic spoilage caused by lactic acid, the “Böckser” (goaty smell) defect caused by hydrogen sulfide, the corked flavor caused, inter alia, by methyltetrahydronaphthalene or the woody flavor caused by 3-methyl-gamma-octanolide. For further information on components causing wine faults and wine disorders, see Römpp Lexikon Chemie [Römpp's chemistry lexicon], 10th edition, 1999, Georg Thieme Verlag, Stuttgart.

In wine, sulfur dioxide, or sulfurous acid, occurs not only in free state but also bound to various constituents. All of the forms together give the total sulfurous acid or SO₂ concentration which must be monitored for defined maximum values. The formation of bound SO₂ is based on what is termed the bisulfite addition to aldehydes and ketones.

The legal analytical provisions and corresponding handbooks for vintners disclose a great number of analytical methods for determining free sulfurous acid or the free SO₂. The known methods are, firstly, very expensive and, secondly, require much labor and time. As a result of many interfering parameters the analyses are inaccurate and are not very reproducible. One problem here is ascorbic acid which is very frequently present in wine and which is erroneously determined as sulfurous acid, for example, in the iodometric method, a titration method. To determine the true value of free sulfurous acid the ascorbic acid must be determined separately and deducted from the value obtained.

In addition to iodometry, it is also known to determine SO₂ by colorimetry, oxidation methods, gas analysis electrodes, polarity determination, reactions with pararosaniline, enzymatic methods or by means of gas chromatography.

So that in the known methods the bound sulfurous acid can also be determined, this is set free by saponification with caustic solution or under heat by distillation with strong acids, which involves further expensive and time-consuming method steps which, in addition, are not sufficiently quantitatively reliable.

The known method described by C. S. Ough loc. cit. is found there in chapter 4 under “Gas chromatography” with the headword “Headspace Analysis”. Using a flame photometer or an electrolytic Hall detector, the SO₂ concentration is measured in the gas space above the liquid sample, in which case, applying Henry's law, the sulfurous acid concentration in solution is calculated. Henry's law, also termed Henry's law of absorption, states that the vapor pressure of a dissolved substance is proportional to its molar fraction in an ideal dilute solution. The proportionality is indicated by an empirical, temperature-dependent Henry constant.

Although the measurement with subsequent calculation leads to a satisfactory result, the use of a Hall detector or a flame photometer, however, is reported to be limiting for the specified method. Not only the cost but also the experimental experience required for using the specified detectors limit their use to large specialized firms. For relatively small vintners, bottlers or analytical laboratories, the known method cannot be used economically.

The analysis of sulfur dioxide in the gas phase especially for environmental measurements is performed, for example, using gas sensors in which the test gas passes through a gas-permeable membrane to the sensor. These sensors, however, according to the manufacturer's details, do not have a specific sensitivity to, for example, sulfur dioxide, rather, they also respond to other test gases, that is to say have a high cross sensitivity. In addition they have a relatively long response time. On account of low sensitivity, this method has not been employed to date for analytical purposes, especially in the fields of food and drink analysis.

The sulfur dioxide analytical methods described in sofar therefore require much time and apparatus, with it being particularly disadvantageous that other components are also co-determined, so that these must be analyzed separately and deducted from the resultant measured value.

Hodgson et al., “Electrochemical Sensor for the Detection of SO₂ in the Low-ppb Range”, Anal. Chem. 1999, Volume 71, pages 2831-2837, describe an electrochemical sensor based on an electrochemical cell. The sensor described makes it possible to detect very low concentrations of atmospheric sulfur dioxide.

Schiavon and Zotti, “Electrochemical Detection of Trace Hydrogen Sulfide in Gaseous Samples by Porous Silver Electrodes Supported on Ion-exchange Membranes (Solid Polymer Electrolytes)”, Anal. Chem. 1995, Volume 67, pages 318-232, describe the detection of traces of H₂S in gaseous samples using an electrochemical sensor. For this purpose the sample is injected using a syringe into an N₂ gas stream which purges the sensor.

### SUMMARY OF THE INVENTION

In view of the above, an object underlying the present invention is to improve the method of the type mentioned at the outset in such a manner that it can be carried out reproducibly and inexpensively, and to provide an apparatus of the type mentioned at the outset with which the new method can be carried out.

With the known method this object is achieved by means of the fact that the concentration of the component in the gas phase is determined by means of a sensor, preferably an electrochemical cell, and is converted into an electrical signal.

An apparatus of the type mentioned at the outset comprises a locating space for the liquid sample, a sensor preferably responding selectively to the component, preferably based on an electrochemical cell, and a gas piping system via which a carrier gas can be passed from the locating space through the sensor.

The object underlying the invention is solved completely in this manner.

This is because the inventor of the present application has recognized that a sensor, in particular based on an electrochemical cell, can be used to analyze the component present in the gas phase in the gas space above the liquid sample and to determine from this the total concentration of the component in the liquid sample. Here the SO₂ content is determined directly, not a reaction product of SO₂, so that the analysis can be carried out rapidly, simply and accurately.

A shaking or stirring motion of the liquid sample can transfer the component to the gas phase and thus to the gas space above the sample so that it can be detected by the sensor.

Sensors of this type are frequently described in the literature, see, for example, Hodgson et al., loc. cit. and Schiavon and Zotti, loc. cit. These sensors are inexpensive modules which can be used with appropriate design for analyzing the most varied components.

The electrochemical cell preferably used in the sensor comprises a membrane onto which a coating sensitive for the component has been applied. The gas comprising the component to be detected comes into direct contact with the sensor surface, which makes possible a very short response time of the sensor. By means of a redox potential which can be set precisely, very small amounts of sulfur dioxide, for example, can be detected selectively.

For further information on electrochemical sensors, see Hodgson et al. loc. cit., and the publications extensively cited there.

According to a further object, the carrier gas can be passed via the gas piping system through the liquid sample and then through the sensor so that the liquid sample is gas-treated or gased with a carrier gas.

The advantage of this measure is that as a result of the gas treatment the component is so to speak displaced from the sample, so that the component present in the sample in free state, for example the SO₂, is quantitatively present in the carrier gas in the gas phase and the measurement signal of the sensor can be converted into the concentration of the free component in the liquid sample.

It is preferred here that the gas piping system is connected to a gas source for the carrier gas.

It is advantageous here that an inert carrier gas or a purified gas is used for transferring the free component from the liquid sample to the gas phase and to feed it to the analysis.

According to another object, the gas piping system comprises a valve switch via which the gas source can be connected to the sensor and the sensor can be connected at its outlet to an exhaust air line, so that the electrochemical cell can be purged by the carrier gas prior to the actual measurement.

It is advantageous here that, prior to the measurement, the sensor is purged with a carrier gas which is free of components to be analyzed, so that all impurities are removed from the sensor which, owing to a preceding measurement, may still be present there.

It is another object that the gas piping system comprises a valve switch via which a stream of carrier gas can be passed in circuit through the liquid sample, so that the carrier gas is so to speak passed through the liquid sample in short circuit.

It is an object that, owing to this circulatory gas-treatment of the sample, before the actual measurement, an equilibrium between gas phase and sample can be established, so that the measured value determined in the following measurement can be converted into the SO₂ concentration in the sample.

It is still another object that the valve switch also passes the carrier gas stream through the sensor, so that the carrier gas is passed in short circuit through the liquid sample and the electrochemical cell.

It is advantageous here that during the actual measurement the risk of concentration change in the sample is decreased, since the gas stream leaving the sensor is recirculated to the sample.

It is further preferred here if the valve switch passes a preferably small portion of the carrier gas through the sensor and passes the remainder via a bypass line back into the locating space.

If only a small portion of the carrier gas is passed through the sensor it is not absolutely necessary to recirculate this small portion of the carrier gas back to the sample as well in order to counteract a concentration change.

It is preferred here if, in the locating space, there is provided a gas-treatment device the inlet of which can optionally be connected via the valve switch to a sensor outlet or a gas takeoff orifice of the locating space.

The gas-treatment device can comprise a frit introduced into the sample or a frit provided at the bottom of the locating space, so that advantageously gas treatment over a large area is made possible, which leads to constant equilibrium between SO₂ in the gas phase and free SO₂ in the sample.

Generally it is preferred if the gas source is connected to the valve switch via an apparatus for moistening the carrier gas, so that the carrier gas is moistened before purging the electrochemical cell.

The moistened standby gas stream advantageously prevents the sensor from drying out and thus ensures reliable and reproducible measurement.

It is also possible to use a sensor in which the gas diffuses through a membrane and only then comes into contact with an active surface of the sensor which is directly in contact with an electrolyte. Such a membrane can consist of a gas-permeable Teflon material, the electrolyte containing 0.5 mol/l of sulfuric acid. However, other electrolytes, for example nitric acid, perchloric acid, can also be used. The direct contact of the active surface with the electrolyte prevents the surface from drying out, so that moistening the carrier gas is not necessary.

Generally it is preferred if the gas source comprises a pump which takes in the ambient air and transports it as carrier gas into the gas piping system, the pump preferably being provided on its intake side with a gas filter to filter out from the carrier gas the contents interfering with the determination of the component. In this manner any contents present, preferably of the component itself, can be filtered out of the carrier gas.

With this measure it is advantageous that an expedient gas supply is provided which can be implemented without gas bottles even for small laboratories. The filter ensures here that the carrier gas is free from SO₂, for example, so that detection error is avoided, in particular with respect to possible cross sensitivity of the sensor.

It is further preferred if the locating space is connected to a sample piping system via which the sample can be charged into the locating space and can be mixed with a dilution medium, so that the sample is diluted before the measurement.

In this advantageous manner supersaturation of the gas phase is avoided, in addition, the volume of the gas space above the sample also being able to be co-influenced. Thus the sulfur dioxide concentration, for example, can be adapted to the measuring range of the sensor, the volume of the gas space also co-influencing this concentration.

It is further preferred if the sample piping system contains a heating/cooling device, to control the temperature of the sample and/or the dilution medium before charging, the locating space further preferably being connected to a heating system, preferably a heating coil, to heat the liquid sample before measurement.

Via the sample piping system, the pH of the liquid sample can also be decreased to the acidic range before measurement.

The acidification and/or heating of the sample advantageously contributes to the release of sulfur dioxide, for example. Sulfur dioxide bound to sample constituents can be released by pH shift and/or temperature elevation.

The inventor of the present application has shown that at high temperature in an acidic environment the adduct of SO₂ and constituent converts completely until finally no adduct is present any longer. In this manner, therefore, all of the bound SO₂ can be converted into free SO₂ and converted in proportion into the gas phase and be determined.

Thus, it is another object that by means of the novel method and the novel apparatus the possibility has been provided of determining free components and components bound to constituents in a liquid sample in a single analytical step completely quantitatively, so that no further measurements of erroneously co-determined constituents, for example ascorbic acid, are necessary, as is the case in the prior art.

Before the measurement, a reagent can be added to the liquid sample which saturates and/or destroys the binding sites of the constituents for the component.

Also in this manner, the equilibrium of the adduct can be shifted to the educts, which in particular is expedient if, to carry out the actual measurement, temperatures must be used at which the equilibrium is not shifted completely to the educts.

Generally, it is further preferred if the locating space has an outlet line and an inlet for a cleaning liquid, the inlet preferably being connected to a cleaning nozzle disposed within the locating space.

This measure has the advantage that the apparatus is so to speak reusable in an automated manner. After completion of analysis of a first sample, this is discharged from the locating space which is then purged with the cleaning medium. The cleaning nozzle distributes the cleaning liquid in this case into the entire locating space so that contamination of the next sample to be measured is prevented.

Overall the novel apparatus is completely automatable, and via the valve switch and the sample piping system many different samples can be analyzed in succession.

While the locating space is being cleaned and charged with a new liquid sample which thereafter is then prepared in a described manner by pH reduction and/or temperature elevation or addition of a reagent, the sensor, in standby, is purged by the filtered and moistened carrier gas, so that here as well all the contaminants are removed.

When the sample has been appropriately prepared, carrier gas is flushed through it in a circulatory procedure, so that an equilibrium is established between the dissolved SO₂ and the SO₂ in the gas phase. Thereafter the valve switch is actuated in such a manner that the sensor is also connected into the circuit so that the carrier gas is then flushed through the sensor and the liquid sample. The total SO₂ present in the sample can then be derived as a function of the measured SO₂ concentration in the gas phase, on the basis of temperature, pressure and pH.

In an embodiment, the carrier gas passed through the sample is split into two portions of which the first is passed in short circuit back into the sample, while the second passes through the sensor and optionally is released into the environment or is also passed back into the sample. If the portion passed through the sensor is small, the recycling to the sample can be dispensed with without marked concentration changes resulting during the measurement time. Upstream of the sensor in this case a mass flow controller can be connected to ensure a constant flow rate through the sensor.

To increase the reliability of measurement, this can be repeated at different temperatures and/or pH values and a corresponding mean can be formed from the series of measurements.

The novel apparatus is of inexpensive and compact structure, so that it can also be used by small vintners, bottling firms or laboratories. The method, furthermore, can be carried out in a very simple and standardized manner, so that no outstanding specialist knowledge is necessary to carry out the method.

Overall, the novel apparatus and the novel method make it possible to determine in a liquid sample not only components, for example, SO_{2,} but also other components causing wine disorders or wine faults in wine or fruit juices.

Furthermore, the novel apparatus and the novel method can also be used to determine corresponding components in other foods, including solid foods. For this it is only necessary to prepare a suspension of the solid substances which then forms the liquid sample and is treated appropriately. In this manner the sulfur dioxide content of foods, for example, which have been treated with sulfur dioxide can be determined.

A particular object in the novel method and the novel apparatus is, firstly, the use of an electrochemical cell and, secondly, the automated gas feeding during sample preparation and analysis. A particular object is also considered to be the sample preparation, in particular the conversion of bound SO₂ to free SO₂. This sample preparation, even without the use of the electrochemical sensor, is also novel and inventive per se, since it can also be carried out using a conventional gas sensor or another measurement method. In this case to saturate the binding sites of the constituents for SO₂ an appropriate reagent can be used.

In the case of an SO₂ measurement, according to the novel method and the novel apparatus, for example 1 ml of the sample is mixed with a reagent which can be a strong acid or a concentrated weak acid and serves for releasing the bound SO₂, passed through a continuous-flow heater and then conducted into an intake vessel in which a dilution medium has been provided which can be, for example, 40 ml of water or else a dilute acid. If free SO₂ is to be determined, 1 ml of the sample is transferred directly into the intake vessel in which a dilute weak acid is present for expelling the SO₂ from the aqueous phase.

The contents of the locating space are then treated by a circulated stream of carrier gas and brought to a constant temperature so that a temperature- and pressure-dependent equilibrium is established. After the equilibrium is established, either all of the carrier gas or a portion of the carrier gas is passed via the sensor. The carrier gas passed in the bypass is recirculated to the locating space to avoid concentration changes, while the carrier gas passed through the sensor can also escape to the exterior.

Obviously, it is also possible to add the sample directly into a reagent, if appropriate to dispense with the continuous-flow heater, and treat the sample directly with gas, that is to say to dispense with the dilution medium, which leads to a smaller sample locating space.

If two reactors are used simultaneously, bound and free SO₂ can be measured at the same time, which leads to savings in time.

By monitoring the external pressure and taking into account the pressure during the evaluation, under defined conditions the result of measurement is improved, because the equilibrium position between liquid and gas phase is pressure-dependent. Keeping temperature as constant as possible can also ensure a reproducible measurement.

### BRIEF DESCRIPTION OF THE DRAWINGS

Further advantages result from the description and the accompanying drawing.

Of course the abovementioned features and the features still to be described below can be employed not only in each of the combinations described, but also in other combinations or alone, without departing from the scope of the present invention.

An embodiment of the invention is shown in the drawing and is described in more detail in the description below. In the drawings:

FIG. 1 shows a simplified diagrammatic representation of the novel apparatus;

FIG. 2 shows a diagrammatic representation of the active part of the sensor used in the apparatus from FIG. 1; and

FIG. 3 shows a more detailed diagrammatic representation of the apparatus from FIG. 1.

### DETAILED DESCRIPTION OF THE PREFERRED EMBODIMENT

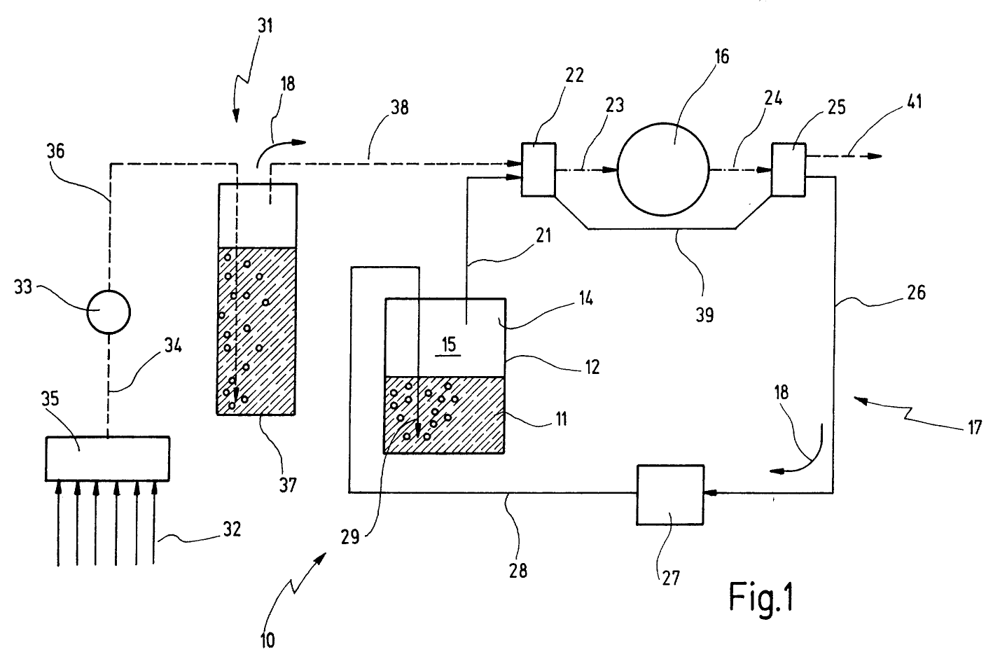

FIG. 1 shows an apparatus 10 for determining a component present in a liquid sample 11 free or bound to constituents. The liquid sample 11 is held in a sample vessel 12 which forms a locating space 14 for the liquid sample 11 over which forms a gas space 15.

The analysis is performed using a sensor 16 which is sensitive for the component. The liquid sample 11 is wine, for example, the sulfur dioxide content of which is to be measured. Sulfur dioxide occurs in wine not only in free state but also bound to various constituents, with all states together giving the total sulfurous acid or SO₂ concentration which is monitored with respect to defined maximum values.

To transport the sulfur dioxide dissolved in wine to the sensor 16, a gas piping system 17 is provided, through which a carrier gas 18 is piped through the liquid sample 11 and the sensor 16 in a circular loop. Because the gas stream leaving the sensor is recirculated back to the sample, during the analysis there is no risk of a concentration change of the component to be measured in the liquid sample 11.

The gas piping system 17 comprises a line 21 which leads from the gas space 15 to a first valve switch 22. The valve switch 22 is connected at its outlet via a line 23 to an inlet of the sensor 16. The outlet of the sensor 16 leads via a line 24 to a second valve switch 25 which is connected via a line 26 at its outlet to a pump 27 which conveys the carrier gas 18 in short circuit. For this purpose the pump 27 is connected at its outlet via a line 28 to a frit 29 through which the carrier gas 18 is introduced over a large surface area into the liquid sample 11.

To charge the measurement short-circuit cycle described in so far with carrier gas 18, the gas piping system 17 is connected to a gas source 31 for the carrier gas 18. While it is possible in principle to provide the carrier gas from a gas bottle, in the embodiment according to FIG. 1, for this purpose ambient air 32 is drawn in. For this purpose a pump 33 is provided which is connected at its intake side via a line 34 to a filter 35 which filters out of the ambient air 32 the contents interfering with the determination of the components. These interfering contents are, for example, SO₂, but also other gases for which the sensor 16 has a cross sensitivity.

The pump 33 is connected at its outlet to a line 36 which leads into a wash bottle 37 in which the filtered ambient air 32 is moistened. From the wash bottle 37, moistened carrier gas 18 passes via a line 38 to the first valve switch 22.

Between the two valve switches 22, 25, there is further provided a bypass line 39 via which the carrier gas 18 can be passed from the valve switch 22, bypassing the sensor 16, to the valve switch 25. The second valve switch 25 is further connected at its outlet to an exhaust air line 41.

At the start of analysis, by means of a suitable position of the valve switch 22 and 25, moistened carrier gas 18 is passed into the part of the gas piping system 17 shown in FIG. 1 with continuous lines. The valve switches 22 and 25 are then connected so that carrier gas in the circuit treats the liquid sample 11 with gas and entrained SO₂ is transported from the gas space 15 via the lines 21, 39 and 26 in short circuit. In this manner, before the actual measurement, an equilibrium is established between gas phase and liquid sample 11, so that the measured value determined in the following measurement can be converted using Henry's law to the sulfurous acid concentration in the liquid sample 11.

In parallel to establishing this equilibrium, the sensor 16 is purged with the inert carrier gas 18 which comes from the wash bottle 37 and is passed to the outside via the exhaust air line 41. In this manner the sensor 16, before the actual measurement, is purged with a carrier gas which is free from a component to be measured and, with respect to the cross sensitivity of the sensor 16, further interfering contents, so that all contaminants which may still be present there owing to a preceding measurement are removed from the sensor 16.

When the sensor 16 has been purged for a sufficiently long time and, moreover, in the short-circuit cycle established via the bypass line 39 a corresponding equilibrium between gas phase and sample 11 has been established, the valve switches 22, 25 are switched so that the sensor 16 is now connected into this circuit. Because the circulation is maintained even during measurement, the concentration of the component to be measured in the gas phase, that is to say present in the gas space 15, in the case of wine as liquid sample 11 that is to say, for example, S0₂, remains constant. The measured value output by the sensor 16 may therefore be converted using Henry's law into the SO₂ concentration in the wine.

The valve switch 22 can alternatively be designed here so that after the equilibrium has been established, where the carrier gas 18 flows solely through the bypass line 39, only a portion of the carrier gas 18 is branched off for the flow through the sensor 16 so that carrier gas 18 continues to be passed through the bypass line 39 back into the locating space 14. The carrier gas passed through the sensor 16 can then, by means of the valve switch 25, either be passed back into the inlet space 14, or else given off to the exterior via the exhaust air line 41.

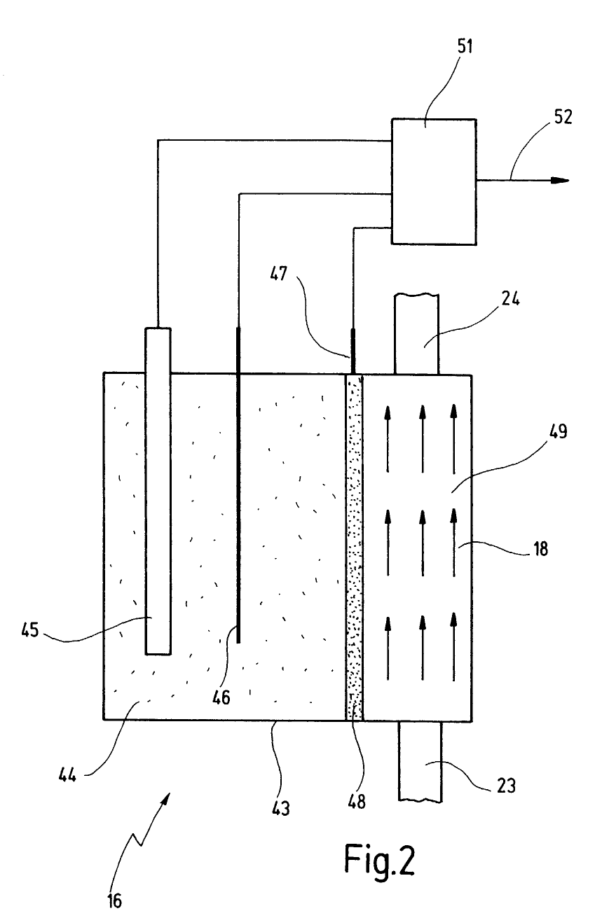

FIG. 2 shows in a diagrammatic representation the sensor 16 which here is an electrochemical cell as described, for example, by Hodgson et al., loc. cit. or Schiavon and Zotti, loc. cit.

According to the diagrammatic representation of FIG. 2 the sensor 16 comprises an electrolyte space 43 in which is situated a suitable electrolyte 44. A reference electrode 45 and a counterelectrode 46 are immersed in the electrolyte 44. In addition, a working electrode 47 is provided which is mounted on a membrane 48 having a sulfur-dioxide-sensitive coating.

The membrane 48 separates the electrolyte space 43 from a gas flow space 49 through which the carrier gas 18 flows parallel to the membrane 48. The gas flow space 49 is connected to the lines 23 and 24.

The electrodes 45, 46 and 47 are connected to a potentiostat circuit 51 which provides at its output 52 a measurement signal which is characteristic of the sulfur dioxide content in the carrier gas 18 and can be converted into the sulfur dioxide concentration in the liquid sample 11.

A circuit in principle for driving the sensor 16 is described by Kissinger and Heinemann in “Laboratory Techniques in Electroanalytical Chemistry”,2nd edition, 1996, Marcel Dekker Inc., New York, Basle, Hong Kong.

As is generally known from the literature, the gas specificity of the sensor 16 depends on the electrolyte, the redox potential adjusted and on the active sensor surface. Via the potentiostat circuit 51, the potential at the working electrode 47 is set with respect to the reference electrode 46 in order to be able to measure the current flow through the cell. To set the potential of the electrolyte 44, the counterelectrode 46 is provided which carries the counterflow from the working electrode 47.

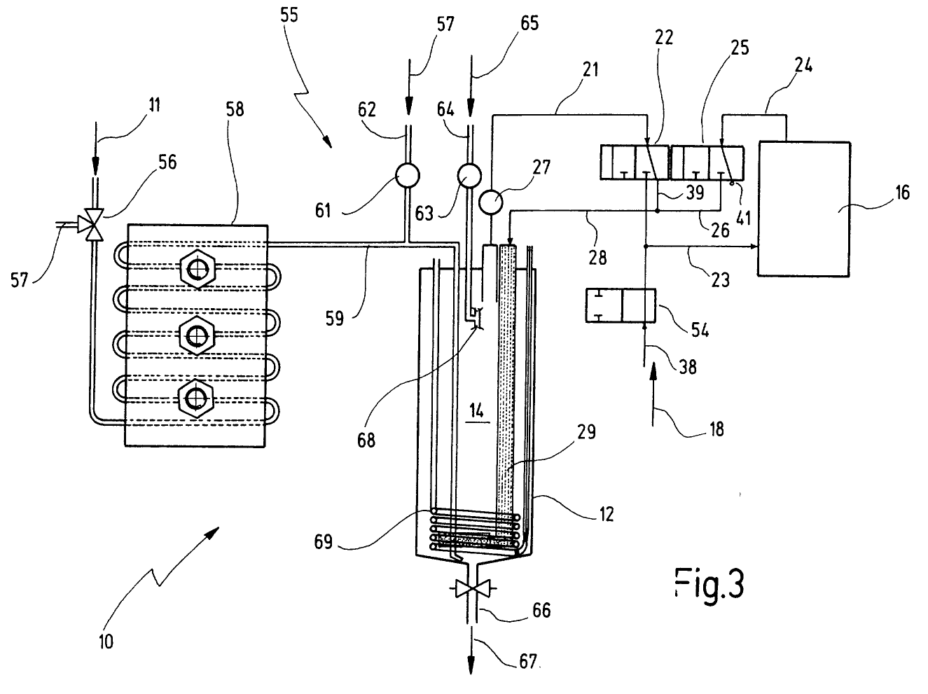

FIG. 3 shows a part of the apparatus 10 from FIG. 1, but in more detail, with the pump 27 not being arranged at the intake of frit 29 but at the outlet of the gas space 15.

As already described with reference to FIG. 1, the valve switches 22, 25 enable in parallel the purge operation of the sensor 16 and the circulation operation by means of the bypass line 39. This state is shown in FIG. 3.

By switching the valve switches 22, 25 and by closing the valve 54 via which the carrier gas 18 comes from the wash bottle 37 the sensor 16 is connected into the circuit so that the component present in the carrier gas 18 can be measured.

To charge the sample vessel 12 with liquid sample 11, a sample piping system 55 is provided, via which the liquid sample 11 can be charged into the locating space 14. At the inlet of the sample piping system 55 there is situated a three-way cock 56 via which the liquid sample 11 is diluted with a suitable dilution medium 57, preferably water. Downstream the three-way cock 56 a heating/cooling device 58 follows in which the liquid sample is heated to the temperature required for analysis. Via a sample line 59 the liquid sample 11 which is diluted with the dilution medium 57 then passes into the locating space 14.

An inlet 62 for further dilution medium 57 is connected via a pump 61 to the sample line 59, via which, for example, the pH of the liquid sample 11 in the locating space 14 can be changed.

Via a further pump 63, by means of an inlet 64, cleaning medium 65 can be passed into the locating space 14, the locating space 14 being drained via an outlet 66 from which after a measurement the liquid sample 11 is drained off as waste 67.

In the sample vessel 12 there is further indicated a heating coil 69 via which the liquid sample 11 can be heated in the locating space 14 before analysis.

Heating the liquid sample 11 before the actual measurement and lowering the pH to the acidic range contributes to the release of the sulfur dioxide. Sulfur dioxide bound to constituents of the liquid sample 11 can be set free in this manner. This is because, at a high temperature in the acidic range, in effect the adduct of SO₂ and constituent completely decomposes until finally no adduct is any longer present. In this manner, therefore, all of the bound SO₂ can be converted into free SO₂ and converted in proportion into the gas phase and determined there.

It is also possible to adjust the pH of the liquid sample 11 via the dilution medium 57 and then to heat the liquid sample appropriately in the heating/cooling device 58 in order further to convert the adduct into the educts. The sample 11 thus prepared is then passed into a defined amount of water in the locating space 14 and analyzed as described. In this manner only a portion of the amount of liquid to be held in the locating space 14 is heated, and the temperature in the sample vessel 12 itself can be kept lower. In addition, under some circumstances this avoids the liquid intensively heated for sample preparation in the sample vessel 12 needing to be cooled again before analysis.

When before analysis an appropriate reagent is added to the liquid sample 11, for example via the inlet 62, the equilibrium can be shifted from the adduct to the educts, this being done, in particular, when, to carry out the analysis, temperatures must be employed at which the equilibrium is not yet completely shifted to the educts.

Cleaning medium 65 can be supplied, for example, via an “in-house connection” with deionized water which can be passed directly via a pressure controller to the cleaning nozzle 68. If deionized water is not available in an in-house connection, there is the possibility of producing cleaning medium 65 directly from the mains water via a pressure reducer and an intermediately connected ion-exchange cartridge and feeding it in. In this manner the required high pressure of approximately 2 bar and the volumetric rate required for cleaning of 1 to 3 l/min can be achieved in an inexpensive manner, without distilled water needing to be provided manually in canisters.

What is claimed is:

1. An apparatus for determining a component present in a liquid sample in free state or bound to constituents, preferably for measuring the SO₂ content in the sample, which further preferably comprises wine, having
a locating space for the liquid sample,
a sensor preferably responding selectively to the component, preferably based on an electrochemical cell, and
a gas piping system via which a carrier gas can be passed from the locating space through the sensor.

2. The apparatus as in claim 1, wherein the carrier gas can be passed via the gas piping system through the liquid sample and then through the sensor.

3. The apparatus as in claim 1 or 2, wherein the gas piping system is connected to a gas source for the carrier gas.

4. The apparatus as in claim 3, wherein the gas piping system comprises a valve switch via which the gas source can be connected to the sensor and the sensor can be connected at its outlet to an exhaust air line.

5. The apparatus as in anyone of claims 1 to 4, wherein the gas piping system comprises a valve switch via which a stream of carrier gas can be circulated through the liquid sample and optionally the sensor or a bypass line.

6. The apparatus as in anyone of claims 1 to 5, wherein the valve switch passes a preferably small portion of the carrier gas through the sensor and passes the remainder via a bypass line back into the locating space.

7. The apparatus as in anyone of claims 4 to 6, wherein, in the locating space, there is provided a gasing device the inlet of which can be connected via the valve switch optionally and at least in part to an outlet of the sensor or a gas takeoff orifice of the locating space.

8. The apparatus as in anyone of claims 1 to 7, wherein the locating space is connected to a sample piping system via which the sample can be filled into the locating space and can be mixed with a dilution medium.

9. The apparatus as in claim 8, wherein the sample piping system comprises a heating/cooling device to control the temperature of the sample and/or the dilution medium prior to filling.

10. The apparatus as in anyone of claims 1 to 9, wherein the locating space is connected to a heating system, preferably a heating coil, to heat the liquid sample.

11. The apparatus as in anyone of claims 1 to 10, wherein the locating space has an outlet line and an inlet for a cleaning liquid.

12. The apparatus as in claim 11, wherein the inlet is connected to a cleaning nozzle disposed within the locating space.

13. The apparatus as in claim 3 and anyone of claims 4 to 12, wherein the gas source is connected to the valve switch via an apparatus for moistening the carrier gas.

14. The apparatus as in anyone of claims 3 to 13, wherein the gas source comprises a pump which takes in ambient air and transports it as carrier gas into the gas piping system.

15. The apparatus as in claim 14, wherein the pump is provided on its intake side with a gas filter to filter out from the carrier gas contents interfering with the determination of the component.

16. A method for determining a component present in a liquid sample in free state or bound to constituents, preferably SO₂, further preferably in wine, in which the component is analyzed in the gas phase from a gas space over the sample,
wherein the concentration of the component present in the gas phase is measured by means of a sensor, preferably an electrochemical cell and is converted into an electrical signal.

17. The method as in claim 16, wherein the liquid sample is gased with a carrier gas.

18. The method as in claim 17, wherein the carrier gas is passed in short circuit through the liquid sample to establish an equilibrium state.

19. The method as in claim 17, wherein the carrier gas is passed in short circuit through the liquid sample and the electrochemical cell.

20. The method as in claim 17, wherein a preferably small portion of the carrier gas is passed through the sensor and the remaining carrier gas is passed in short circuit back through the sample.

21. The method as in anyone of claims 16 to 20, wherein the electrochemical cell is purged with a carrier gas before the actual measurement.

22. The method as in claim 21, wherein the carrier gas is moistened.

23. The method as in anyone of claims 20 to 22, wherein any contents of the component possibly present are filtered out of the carrier gas.

24. The method as in anyone of claims 16 to 23, wherein the liquid sample is heated prior to analysis.

25. The method as in anyone of claims 16 to 24, wherein the pH of the liquid sample is lowered to the acidic range prior to analysis.

26. The method as in anyone of claims 16 to 25, wherein prior to the analysis there is added to the liquid sample a reagent which saturates and/or destroys the binding sites of the constituents for the component.
